(19) United States
(12) Patent Application Publication
(10) Pub. No.: US 2026/0171631 A1
(43) Pub. Date: Jun. 18, 2026

(54) METHOD FOR MANUFACTURING BATTERY CELL

(71) Applicant: MAZDA MOTOR CORPORATION, Hiroshima (JP)

(72) Inventors: Taiki YOSHIMURA, Hiroshima (JP); Shun KUWAKO, Hiroshima (JP); Takanori KAJIMOTO, Hiroshima (JP); Shinichi SHIMIZU, Hiroshima (JP); Kosaku ITO, Hiroshima (JP)

(73) Assignee: MAZDA MOTOR CORPORATION, Hiroshima (JP)

(21) Appl. No.: 19/418,344

(22) Filed: Dec. 12, 2025

(30) Foreign Application Priority Data
Dec. 18, 2024 (JP) 2024-222329

(51) Int. Cl. H01M 50/54; H01M 10/0525; H01M 10/0585; H01M 50/536

(52) U.S. Cl. CPC H01M 50/54; H01M 10/0525; H01M 10/0585; H01M 50/536

(57) ABSTRACT

A manufacturing method to prevent insufficient welding of resin pieces during manufacture of a battery cell includes stacking electrode sheets in a layering direction, the electrode sheets each including an electrode and a current collector. The electrodes are located in a container, and the current collectors are each connected to the electrode in the container and protrude outward from an opening of the container. The method also includes preheating resin pieces, located between adjacently stacked current collectors, through the current collectors. After preheating is started, pressurizing and heating the resin pieces is started from an outside toward a center in the layering direction at a position of the opening of the container. Resin pieces are welded together between the current collectors, and the opening of the container is sealed.

### TECHNICAL FIELD

A technique disclosed herein relates to a method for manufacturing a battery cell.

### BACKGROUND

Japanese Patent Laid-Open No. 2009-272161 describes a conventional laminated battery. The laminated battery is a battery in which an electrode body is housed in an exterior member. The laminated battery includes a plurality of current-collecting terminals that are pulled out from the electrode body to the outside of the exterior member. The plurality of current-collecting terminals are stacked with thermoplastic resin pieces interposed therebetween. At the periphery of the exterior member, the resin pieces are welded to each other and to the exterior member, thereby closing the periphery of the exterior member from which the current-collecting terminals are drawn out.

In the laminated battery, each of the plurality of current-collecting terminals is pulled out to the outside of the exterior member. The plurality of current-collecting terminals are not connected to each other in the exterior member. In the laminated battery, the space in the exterior member can be used to expand the electrode body. The structure of the laminated battery is advantageous for improving the energy density of the battery.

### SUMMARY

The laminated battery described herein above is manufactured by a heat sealing process. In the heat sealing process, the stacked resin pieces at the periphery of the exterior member are welded together by being pressed by the hot plate, which is an energy supply source, in the stacking direction. The laminated battery described in Japanese Patent Laid-Open No. 2009-272161 has a small number of current-collecting terminals drawn out to the outside of the exterior member. The welding of resin pieces in the heat sealing process is relatively easy.

When the number of current-collecting terminals drawn out of the exterior member increases, a large number of layered resin pieces must be welded together. If the number of layered resin pieces is large, the resin pieces located in the center of the layering direction are far away from the energy supply source for welding. In manufacturing a laminated battery with a large number of current-collecting terminals, sufficient energy may not be supplied to the resin pieces located in the center, resulting in insufficient welding of the resin pieces located in the center.

A technique disclosed herein prevents insufficient welding of resin pieces during manufacture of a battery cell.

The technique disclosed herein relates to a method for manufacturing a battery cell. This manufacturing method includes:
stacking electrode sheets in a layering direction, the electrode sheets each including an electrode and a current collector, the electrodes being located in a container, the current collectors each being connected to the electrode in the container and protruding outward from an opening of the container;
preheating resin pieces, located between the adjacently stacked current collectors, through the current collectors;
after the preheating is started, starting pressurizing and heating the resin pieces from an outside toward a center in the layering direction at a position of the opening of the container; and
welding the resin pieces together between the current collectors, and sealing the opening of the container.

In the battery cell manufactured by this manufacturing method, each of the plurality of stacked current collectors protrudes outside the container through the opening of the container. The plurality of current collectors are connected to electrodes with the same polarity, for example. Inside the container, the plurality of current collectors are not connected to each other. The connection space between the current collectors inside the container can be omitted. The electrodes of the battery cell can be expanded by using the space inside the container. The battery cell of this structure can have a high energy density.

The opening of the container is sealed with resin pieces. The resin pieces are, for example, a thermoplastic resin pieces. During manufacturing the battery cell, the resin pieces between the stacked current collectors at the opening position of the container are pressurized and heated from the outside toward the center in the layering direction. For example, a pair of hot plates positioned on the outside of the container may be used with a plurality of resin pieces interposed therebetween in the layering direction, and at the same time, the hot plates may supply heat energy to the resin pieces from the outside toward the center in the layering direction. The heat energy is transferred in order from the resin pieces on the outside to the resin pieces in the center in the layering direction. The heat energy supplied to the resin pieces located in the center in the layering direction is likely to be lower than the heat energy supplied to the resin pieces located on the outside in the layering direction due to attenuation.

In the disclosed manufacturing method, the resin pieces are preheated through the current collectors before start of pressurization and heating of the resin pieces. Heat energy is efficiently supplied to the resin pieces located in the center in the layering direction through the current collectors located in the center in the layering direction.

Preheating of the resin pieces through the current collectors is combined with pressurization and heating from the outside in the layering direction, so that heat energy is sufficiently supplied to both the resin pieces located on the outside in the layering direction and the resin pieces located in the center in the layering direction. As a result, all the resin pieces are welded together throughout the entire layering direction during manufacturing the battery cell. The sealing strength of the opening of the container is prevented from varying from part to part.

When the resin pieces are not preheated through the current collectors, it is necessary to continue pressurization and heating for a relatively long time until the heat energy supplied from the outside in the layering direction sufficiently reaches the resin pieces in the center in the layering direction. If the pressurization and heating time is long, excessive heat energy may be supplied to the resin pieces on the outside in the layering direction.

When preheating through the current collectors is performed in advance, it is possible to shorten the time from when pressurization and heating are started from the outside in the layering direction to when sufficient heat energy is supplied to the resin pieces in the center in the layering direction. Shortening the pressurizing and heating time makes it possible to sufficiently supply heat energy to the resin pieces in the center in the layering direction while preventing excessively supplying heat energy to the resin pieces on the outside in the layering direction. The opening of the container is stably sealed. In addition, shortening the pressurizing and heating time increases the manufacturing efficiency of the battery cell. Each current collector generally has a high thermal conductivity. After start of preheating, the resin pieces are quickly heated through the current collectors. The time difference between start of preheating through the current collectors and the start of pressurization and heating from the outside in the layering direction does not need to be large.

Note that the preheating of the resin pieces through the current collector may be performed on only a part of the plurality of resins stacked in the layering direction. For example, the resin pieces located in the center in the layering direction may be preheated through the current collectors. This is because the heat energy supplied to the resin pieces located in the center of the layering direction is likely to be relatively low.

Preheating through the current collectors may be continued also after start of pressurization and heating of the resin pieces.

If preheating through the current collectors is ended during pressurization and heating of the resin pieces, the temperature of the resin pieces may drop due to heat dissipation through the current collectors. Preheating through the current collectors is continued also after start of pressurization and heating of the resin pieces, thereby preventing heat dissipation through the current collectors. Due to the continued preheating, all the resin pieces are welded together and the opening of the container is stably sealed.

Preheating through the current collectors is ended before or at the same time as ending heating of the resin pieces.

If preheating through the current collectors is continued even after heating of the resin pieces is completed, the temperature of the resin pieces may become too high. When preheating through the current collectors is ended before or at the same time as ending heating of the resin pieces, excessive temperature rise of the resin pieces is prevented.

Pressurization of the resin pieces may be completed at the same time as or after completion of heating of the resin pieces.

Since the heating of the resin pieces is not continued after end of pressurization of the resin pieces, the resin pieces are prevented from being excessively supplied with heat energy. Since the resin pieces are sufficiently pressurized while heat energy is appropriately supplied to the resin, the opening of the container is appropriately sealed. Note that pressurization of the resin pieces may be continued after heating of the resin pieces is completed. Continued pressurization causes the resin pieces to be stably welded together. Continued pressurization is advantageous for improving the sealing quality of the opening of the container.

Preheating through the current collectors may be performed by a first hot plate, and pressurization and heating of the resin pieces may be performed by a second hot plate that is different from the first hot plate.

Use of two types of hot plates, the first hot plate and the second hot plate, makes it possible to individually set the temperature of the first hot plate and the temperature of the second hot plate. In addition, it is possible to individually set the start and end of heating with the first hot plate and the start and end of heating with the second hot plate. The plurality of stacked resin pieces are all appropriately welded together. The sealing quality of the opening of the container is improved.

The first hot plate may heat the plurality of current collectors in a state in which the current collectors are stacked in the layering direction.

The first hot plate is used to heat the plurality of current collectors collectively, allowing each of the stacked resin pieces to be preheated appropriately.

The method for manufacturing the battery cell described above can prevent the welding of the resin pieces from being insufficient during manufacturing the battery cell.

### BRIEF DESCRIPTION OF THE DRAWINGS

FIG. 1 is a cross-sectional view of a battery cell.

FIG. 2 shows a part of a manufacturing procedure of a battery cell.

FIG. 3 shows a part of the manufacturing procedure of the battery cell.

FIG. 4 shows a part of the manufacturing procedure of the battery cell.

FIG. 5 shows a part of the manufacturing procedure of the battery cell.

### DETAILED DESCRIPTION

Hereinafter, an embodiment of a manufacturing procedure of a battery cell will be described with reference to the drawings. The battery cell manufacturing procedure described here is an example.

### Battery Cell Structure

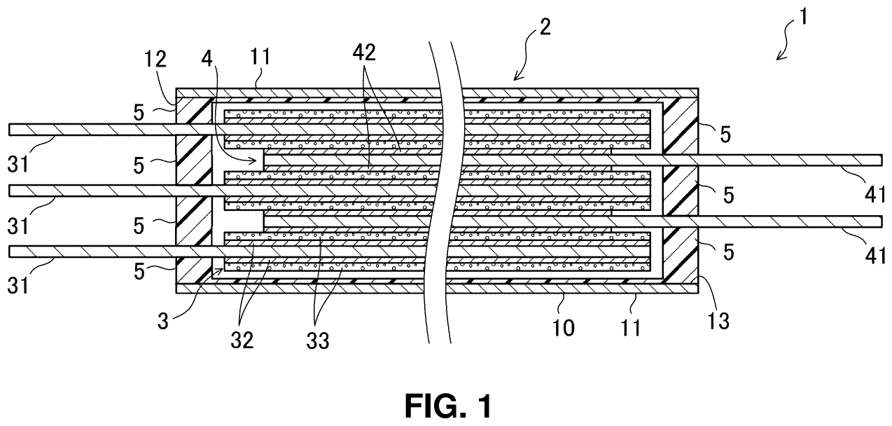

FIG. 1 schematically shows an overall structure of a battery cell 1. The battery cell 1 is a secondary battery. The battery cell 1 is, for example, a lithium ion battery.

The battery cell 1 is a so-called pouch-type battery. The battery cell 1 includes an electricity generation element 2 and a container 10. The container 10 is sealed with the electricity generation element 2 and the electrolyte contained therein. The container 10 is formed into a bag shape by folding one laminate material 11 or by stacking two laminate materials 11. The laminate material 11 has a three-layer structure in which a metal layer is interposed between two resin layers. The metal layer is, for example, aluminum or stainless steel. The resin layer is made of, for example, polypropylene (PP) or polyethylene (PE).

The electricity generation element 2 has first electrode sheets 3. The first electrode sheets 3 are, for example, negative electrode sheets. The electricity generation element 2 has second electrode sheets 4. The second electrode sheets 4 are, for example, positive electrode sheets. The first electrode sheets 3 and the second electrode sheets 4 are alternately stacked. The numbers of the first electrode sheets 3 and the second electrode sheets 4 are optional in the electricity generation element 2. The electricity generation element 2 is an electrode-layered product. In the following, the direction in which the first electrode sheets 3 and the second electrode sheets 4 are layered may be referred to as the layering direction. The layering direction is the up-down direction on the paper surface of FIG. 1 and FIGS. 2 to 5 described later.

Each first electrode sheet 3 has a current collector 31. The current collector 31 is a thin plate or foil that extends in a direction perpendicular to the layering direction. An end of the current collector 31, that is, the left end in FIG. 1, protrudes outside the container 10 from the first opening 12 of the container 10.

A first surface and a second surface of each current collector 31 located inside the container 10 are coated with an active material. The first surface is the upper surface of the current collector 31 in FIG. 1, and the second surface is the lower surface of the current collector 31 in FIG. 1. The active material forms first electrodes 32. The current collector 31 is connected to the first electrodes 32 inside the container 10.

Each first electrode sheet 3 has separators 33. Each separator 33 separates the first electrode 32 of the first electrode sheet 3 from a second electrode 42 of the second electrode sheet 4, which will be described later. The separator 33 is, for example, a porous material through which ionic substances can pass.

Each separator 33 covers the surface of a corresponding one of the two first electrodes 32 in the first electrode sheet 3. The separator 33 may be formed by pasting a film forming the separator 33 to the first electrode 32. The separator 33 may also be formed by drying the slurry applied to the first electrode 32. The area of the separator 33 may be the same as or larger than the area of the first electrode sheet 3.

Each second electrode sheet 4 has a current collector 41. The current collector 41 is a thin plate or foil that extends in a direction perpendicular to the layering direction. An end of the current collector 41, that is, the right end in FIG. 1, protrudes outside the container 10 from the second opening 13 of the container 10. The second opening 13 is an opening opposite to the first opening 12 in the direction perpendicular to the layering direction. The protruding direction of the current collector 41 is not limited to the opposite direction to the protruding direction of the current collector 31.

A first surface and a second surface of each current collector 41 located inside the container 10 are coated with an active material. The active material forms second electrodes 42. The current collector 41 is connected to the second electrodes 42 inside the container 10.

As described above, the first electrode sheets 3 and the second electrode sheets 4 are alternately layered. The first electrodes 32 and the second electrodes 42 are stacked in the layering direction inside the container 10 via the separators 33.

The first opening 12 of the container 10 is sealed with resin pieces 5. Each resin piece 5 is a sealing material. The resin pieces 5 are located between the laminate material 11 and the current collectors 31, and between the current collectors 31. Similarly, the second opening 13 is sealed with resin pieces 5. The resin pieces 5 are located between the laminate material 11 and the current collectors 41, and between the current collectors 41.

The plurality of current collectors 31 are not connected to each other inside the container 10 and protrude individually outside the container 10. Similarly, the plurality of current collectors 41 are not connected to each other inside the container 10 and protrude individually outside the container 10. Inside the container 10, since the connection space of the current collectors 31 and 41 can be omitted, the areas of the first electrodes 32 and the second electrodes 42 can be increased by the omitted space. The battery cell 1 can have a high energy density.

### Method for Manufacturing Battery Cell

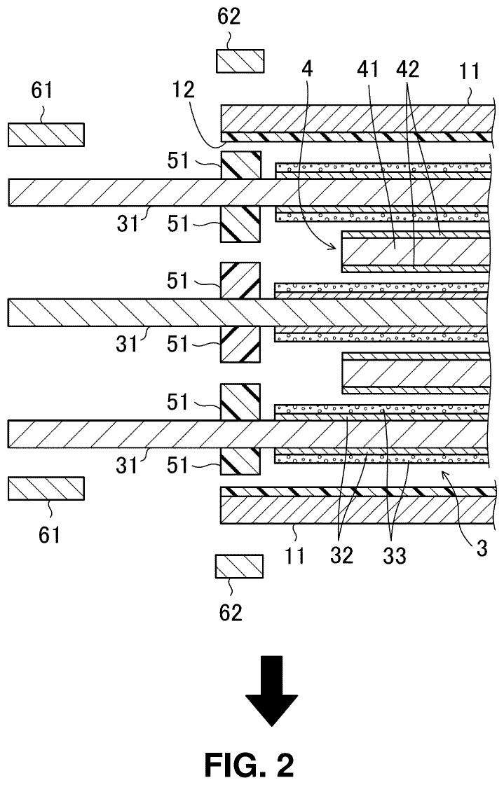

Next, a method for manufacturing the battery cell 1 will be described with reference to FIGS. 2, 3, 4, and 5. The method for manufacturing the battery cell 1 proceeds in the order of FIGS. 2, 3, 4, and 5. Here, the method for manufacturing the battery cell 1 will be described using the welding of the resin pieces at the first opening 12 as an example, but the same applies to the welding of the resin pieces at the second opening 13.

First, the first electrode sheets 3 and the second electrode sheets 4 are prepared. As described above, each first electrode sheet 3 has a current collector 31, first electrodes 32, and separators 33. The first electrode sheet 3 also has resin pieces 51 (see FIG. 2). Each resin piece 51 is located on the current collector 31 between the end of the current collector 31 and the first electrodes 32. Each resin piece 51 is welded in advance to a corresponding one of the first surfaces and second surfaces of the current collectors 31.

Each second electrode sheet 4 has a current collector 41, second electrodes 42, and resin pieces. Each resin piece of the second electrode sheet 4 is located on the current collector 41 between the end of the current collector 41 and the second electrodes 42, similarly to the resin piece 51 of the first electrode sheet 3. The resin pieces are welded in advance to a corresponding one of the first surfaces and second surfaces of the current collectors 41.

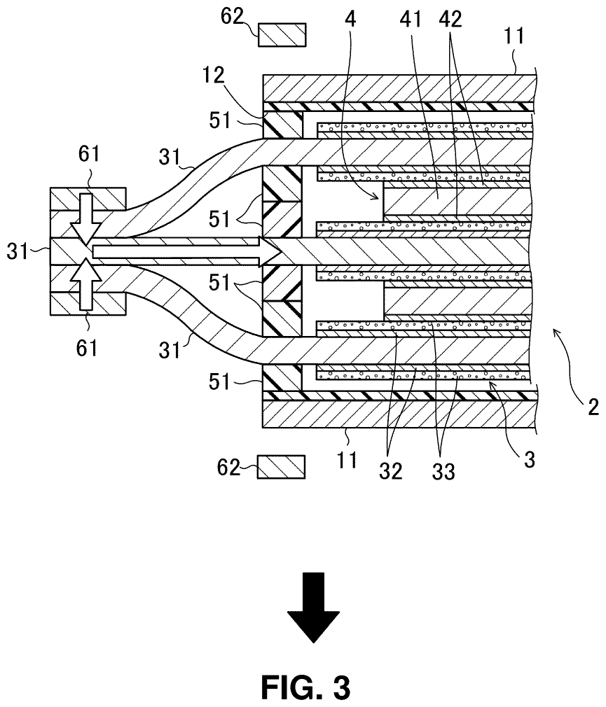

Next, the first electrode sheets 3 and the second electrode sheets 4 are layered alternately as shown in FIG. 2. As shown in FIG. 3, the first electrodes 32 and the second electrodes 42 are stacked with the separators 33 interposed therebetween. The resin pieces 51 are located between the current collectors 31 of the first electrode sheets 3. The resin pieces 51 are aligned in the layering direction. The resin pieces are also located between the current collectors 41 of the second electrode sheets 4.

Each resin piece 51 is a thermoplastic resin piece. The resin piece 51 is made of a material selected from cast polypropylene (CPP), low density polyethylene (LDPE), linear low density polyethylene (LLDPE), high density polyethylene (HDPE), oriented polypropylene (OPP), polyethylene terephthalate (PET), or oriented nylon (ONY).

After the first electrode sheets 3 and the second electrode sheets 4 are layered to form the electricity generation element 2, the laminate material 11 is placed on the electricity generation element 2. As shown in FIG. 3, the position of the edge of the laminate material 11 (the left edge in FIG. 3) corresponds to the position of the resin pieces 51. The laminate material 11 is located outside the outermost current collectors 31 in the layering direction. In other words, the laminate material 11 is located above the topmost current collector 31 and below the bottommost current collector 31 in the up-down direction in FIG. 3.

Next, preheating of the resin pieces 51 is started. The resin pieces 51 are preheated using a pair of first hot plates 61, 61. Between the pair of first hot plates 61, 61 in the layering direction, the plurality of current collectors 31 are interposed at the end positions of the current collectors 31. The plurality of current collectors 31 are stacked in the layering direction. The high-temperature first hot plates 61, 61 heat the plurality of current collectors 31 in a state in which the current collectors 31 are stacked in the layering direction. As shown by white arrows in FIG. 3, heat energy is supplied from the pair of first hot plates 61, 61 through the current collectors 31 to the resin pieces 51. Note that in FIG. 3, an arrow is drawn only on the current collector 31 in the center of the layering direction, but heat energy is supplied to each of the resin pieces 51 in contact with the current collector 31 through the current collector 31. Each resin piece 51 is heated.

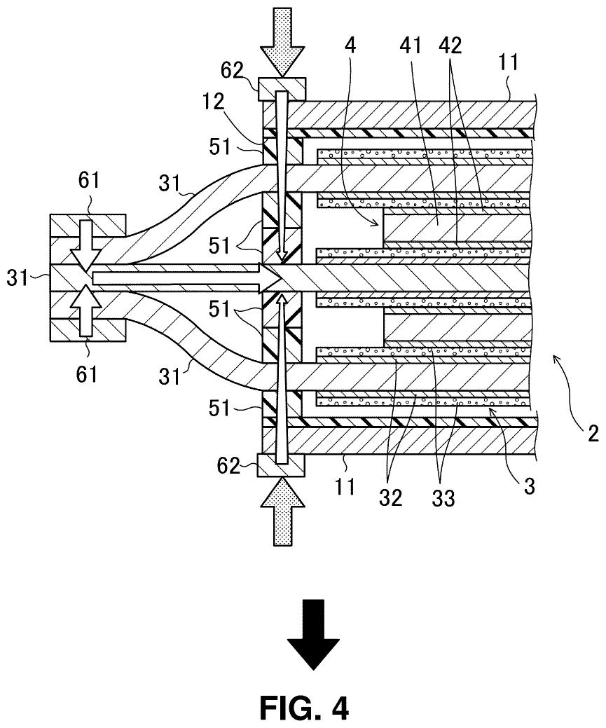

After the preheating of the resin pieces 51 is started, hot plate welding of the resin pieces 51 aligned in the layering direction is started as shown in FIG. 4. The hot plate welding is performed using a pair of second hot plates 62, 62. The pair of second hot plates 62, 62 are positioned on the outside of the laminate material 11, and pressurize the resin pieces 51 aligned in the layering direction from the outside to the center in the layering direction (see gray arrows in FIG. 4). At the same time, the pair of second hot plates 62, 62 heat the resin pieces 51 aligned in the layering direction. Preheating with the first hot plates 61, 61 continues also after hot plate welding with the second hot plates 62, 62 is started.

The heat energy from the high-temperature second hot plates 62, 62 is transmitted from the outside toward the center in the layering direction through the laminate material 11, resin pieces 51, and current collectors 31. The resin pieces 51 receive heat energy and melt.

Here, as shown by white arrows in FIG. 4, the heat energy supplied from the second hot plates 62, 62 to the resin pieces 51 located in the center in the layering direction is likely to be lower than the heat energy supplied to the resin pieces 51 located on the outside in the layering direction due to attenuation. The resin pieces 51 located in the center in the layering direction may not be sufficiently welded together.

In contrast, the resin pieces 51 located in the center in the layering direction is preheated through the current collectors 31. The resin pieces 51 located in the center in the layering direction are heated through the current collectors 31, and heat energy is also supplied from the second hot plates 62 in the layering direction. Sufficient heat energy is supplied to the resin pieces 51 located in the center in the layering direction.

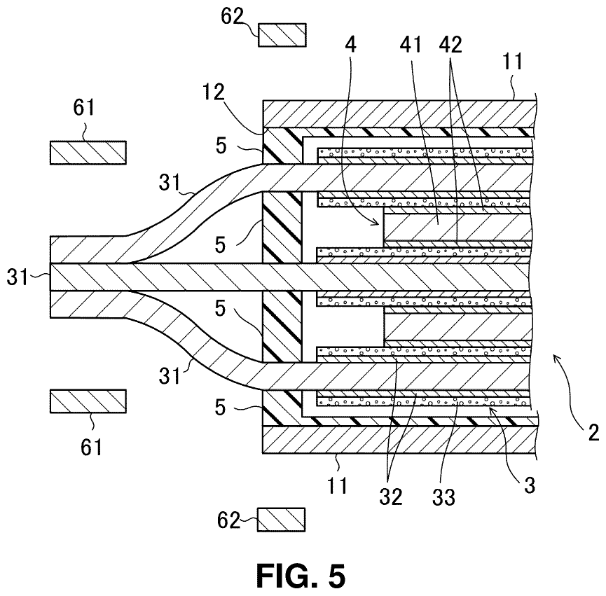

In this way, heat energy is sufficiently supplied to both the resin pieces 51 located on the outside in the layering direction and the resin pieces 51 located in the center in the layering direction. As shown in FIG. 5, at the opening (here, the first opening 12) of the container 10, the parts between the laminate material 11 and the current collectors 31, and the parts between the current collectors 31 are sealed with the welded resin pieces 5.

When welding of the resin pieces 51 is completed, the pressurization and heating with the second hot plates 62, 62 ends, and heating with the first hot plates 61, 61 also ends. If the first hot plates 61, 61 are separated from the current collectors 31, the current collectors 31 may be separated from each other in the layering direction.

In the manufacturing method described above, the resin pieces 51 are preheated using the first hot plates 61, 61 before hot plate welding is started using the second hot plates 62, 62. Heat energy is supplied sufficiently to both the resin pieces 51 located in the center in the layering direction and the resin pieces 51 located at the outside in the layering direction.

When the resin pieces 51 are preheated through the current collectors 31 prior to hot plate welding, it is possible to shorten the time from when pressurization and heating is started from the outside in the layering direction to when sufficient heat energy is supplied to the resin pieces 51 in the center in the layering direction. The resin pieces 51 on the outside in the layering direction can be prevented from being excessively supplied with heat energy.

This manufacturing method prevents the sealing strength of the openings 12, 13 of the container 10 from varying from part to part. Since all of the resin pieces 51 can be stably welded together, the sealing quality of the openings 12 and 13 of the container 10 is improved.

Since the thermal conductivity of the current collectors 31 is high, the resin pieces 51 are quickly heated through the current collectors 31 after start of preheating. The hot plate welding may be started promptly after start of preheating through the current collectors 31. Starting preheating through the current collectors 31 in advance does not lengthen the manufacturing time, and the time for hot plate welding is shortened, so that the manufacturing efficiency of the battery cell is improved.

Furthermore, in the above-described manufacturing method, preheating through the current collectors 31 with the first hot plates 61, 61 continues also after start of hot plate welding using the second hot plates 62, 62. Heat dissipation through the current collectors 31 is prevented during hot plate welding with the second hot plates 62, 62. Since the resin pieces 51 are prevented from drop in temperature due to heat dissipation, the resin pieces 51 can be stably welded together.

The preheating through the current collectors 31 with the first hot plates 61, 61 ends when the hot plate welding using the second hot plates 62, 62 is completed. If preheating through the current collectors 31 is continued even after hot plate welding is completed, the heat energy supplied to the resin pieces 51 may be excessive. When the hot plate welding is completed, preheating through the current collectors 31 also ends, thereby preventing excessive supply of heat energy to the resin pieces 51.

Note that preheating through the current collectors 31 with the first hot plates 61, 61 may end before the completion of hot plate welding using the second hot plates 62, 62.

Furthermore, use of two types of hot plates, the first hot plates 61 and the second hot plates 62, makes it possible to individually set the temperature of the first hot plates 61 and the temperature of the second hot plates 62. In addition, it is possible to individually set the start and end of heating with the first hot plates 61 and the start and end of heating with the second hot plates 62. In the manufacturing method described above, the preheating of the resin pieces 51 using the first hot plates 61 and the hot plate welding of the resin pieces 51 using the second hot plates 62 can be controlled independently of each other. Independent control of preheating and hot plate welding improves the sealing quality of the openings 12, 13 of the container 10.

The first hot plates 61, 61 heat the plurality of current collectors 31 in a state in which they are stacked in the layering direction, so that the plurality of current collectors 31 are heated together. Each of the plurality of stacked resin pieces 51 can be preheated, and heat dissipation from each of the plurality of current collectors 31 during hot plate welding can be prevented, so that all of the plurality of resin pieces 51 can be appropriately welded together.

### Modifications

The first hot plates 61, 61 may selectively heat the current collectors 31, 41 located in the center in the layering direction, for example.

Furthermore, with regard to the end of hot plate welding with the second hot plates 62, if the end of pressurization and the end of heating with the second hot plates 62 can be set independently, the second hot plates 62 may continue pressurization even after the end of heating. Continued pressurization allows all of the resin pieces 51 to be properly welded together, improving the sealing quality of the openings 12, 13 of the container 10.

Instead of hot plate welding using the second hot plates 62, for example, vibration welding, ultrasonic welding, or high-frequency welding may supply energy to the resin pieces 51 from the outside toward the center in the layering direction, thereby welding the resin pieces 51 together. Even if there is attenuation of energy for welding in various welding techniques, it is possible to combine preheating of the resin pieces through the current collectors 31, 41 in the above-described manufacturing method, thereby sufficiently welding the resin pieces 51, located in the center in the layering direction, together.

The preheating through the current collectors 31, 41 and the hot plate welding may be performed using the same hot plates.

The preheating through the current collectors 31, 41 may be ended at or before the start of the hot plate welding.

What is claimed is:

1. A method for manufacturing a battery cell, the method comprising:
stacking electrode sheets in a layering direction, the electrode sheets each including an electrode and a current collector, the electrodes being located in a container, the current collectors each being connected to the electrode in the container and protruding outward from an opening of the container;
preheating resin pieces, located between the adjacently stacked current collectors, through the current collectors;
after the preheating is started, starting pressurizing and heating the resin pieces from an outside toward a center in the layering direction at a position of the opening of the container; and
welding the resin pieces together between the current collectors, and sealing the opening of the container.

2. The method for manufacturing the battery cell according to claim 1, wherein
preheating through the current collectors is continued also after start of pressurization and heating of the resin pieces.

3. The method for manufacturing the battery cell according to claim 2, wherein
preheating through the current collectors is ended before or at the same time as ending heating of the resin pieces.

4. The method for manufacturing the battery cell according to claim 3, wherein
pressurization of the resin pieces is completed at the same time as or after completion of heating of the resin pieces.

5. The method for manufacturing the battery cell according to claim 1, wherein
preheating through the current collectors is performed by a first hot plate, and
pressurization and heating of the resin pieces is performed by a second hot plate that is different from the first hot plate.

6. The method for manufacturing the battery cell according to claim 5, wherein
the first hot plate heats the plurality of current collectors in a state in which the current collectors are stacked in the layering direction.
